(19) United States
(12) Patent Application Publication
(10) Pub. No.: US 2013/0082429 A1
(43) Pub. Date: Apr. 4, 2013

(54) Method for Manufacturing Frame of C-Clamp, Frame of C-Clamp and C-Clamp

(71) Applicants: Jari Kiviniemi, Siikajoki (FI); Juha Miinala, Kemijarvi (FI); Timo Lehto, Kemi (FI)

(72) Inventors: Jari Kiviniemi, Siikajoki (FI); Juha Miinala, Kemijarvi (FI); Timo Lehto, Kemi (FI)

(73) Assignee: Autoprod Oy, Kemi (FI)

(21) Appl. No.: 13/702,051

(22) PCT Filed: Jun. 22, 2011
(86) PCT No.: PCT/FI2011/050604

§ 371 Date: Dec. 4, 2012

(30) Foreign Application Priority Data
Jun. 23, 2010 (FI) 20105730

(51) Int. Cl. B23P 15/00; B23P 13/00; B25B 5/16

(52) U.S. Cl. CPC B23P 15/00; B25B 5/16; B23P 13/00
USPC 269/286; 29/428; 29/416; 269/86

(57) ABSTRACT

A method comprises manufacturing a frame of a C-clamp, which has a lower jaw, an upper jaw and a mouth between the lower jaw and upper jaw. The method comprises forming a lower end plate and an upper end plate and at least two frame plates, which have a lower branch and an upper branch. The lower branches of the frame plates are attached to the lower end plate and the upper branches to the upper end plate, so that the frame plates settle in a parallel manner at a distance (e) from each other. The joined frame plates and end plates form the frame of the C-clamp. The frame plates are formed by machining a steel plate of ultra-strength steel only with machining methods, which do not substantially heat up the material being machined. Suitable machining methods are for example chipping machining methods or water cutting. The lower branches are attached to the lower end plate and the upper branches are attached to the upper end plate by welding or with mechanical attaching means. The attaching point of the end plates is situated as far away as possible from the most stressed point in the frame plates, so a localized decrease in strength in the ultra-strength steel possibly caused by the welding does not affect the total strength of the frame in a decreasing way. The number of frame plates can be selected according to the strength requirements of the frame. There can thus be for example three, four, five, six, seven or eight frame plates.

The invention relates to a method for manufacturing the frame of a C-clamp, which frame has a lower jaw, an upper jaw and a mouth between the lower jaw and upper jaw. The invention also relates to a frame of a C-clamp and a C-clamp manufactured with the method.

Mobile C-clamps are used in many assembly jobs, such as when manufacturing nail plate trusses, for clamping together various structural parts and connecting pieces. Prior art C-clamps have a frame manufactured from steel, which in accordance to its name is reminiscent of a letter C, which has an immobile upper jaw and lower jaw and a mouth remaining between said parts. A hydraulic cylinder is attached to the upper jaw, at the end of the upwards projecting piston of which there is a clamp plate, which can be pressed against a counter plate in the lower jaw.

The frame of prior art C-clamps is a uniform steel part manufactured with casting technique. Due to the manufacturing manner of the frame and the endurance requirements of the frame the frames of C-clamps are to their structure large and heavy, wherefore the manufacturing and material costs of the frame are comparatively high. The manufacturing method of the clamp requires the making of a separate mould for each differently sized frame, which further raises the manufacturing costs of the frame. The large size and weight of the frames of the C-clamps makes the use of the clamps difficult especially in situations, where C-clamps often need to be moved from one place to another. Such constantly movable C-clamps are used among others when assembling roof trusses.

Publication US 2004/0181936 A1 shows a C-clamp, the frame of which has a curved inner circle and a curved outer circle, which are connected to each other with internal ribs, so that the frame becomes a grid-like structure.

An object of the invention is to provide a new method for manufacturing the frame of a C-clamp, a frame of a C-clamp and a C-clamp manufactured with the method, by means of which the drawbacks and disadvantages relating to prior art may be significantly reduced.

The objects of the invention are obtained with a method, a frame and a C-clamp, which are characterised in what is presented in the independent claims. Some advantageous embodiments of the invention are presented in the dependent claims.

The method according to the invention comprises manufacturing a frame of a C-clamp, which has a lower jaw, an upper jaw and a mouth between the lower jaw and upper jaw. At least two frame plates are formed in the method, which have a lower branch and an upper branch and a gap remaining between them. In addition to the above-mentioned parts, a lower end plate and an upper end plate are formed. Thereafter the lower branches of the previously formed frame plates are attached to the lower end plate and the upper branches to the upper end plate, so that the frame plates settle in a parallel manner at a distance e from each other. The joined frame plates and end plates form the frame of the C-clamp. When using the C-clamp a large bending moment is directed at the juncture of the upper branches and lower branches, i.e. the frame is the most stressed part of the clamp. In the method this part of the C-clamp, which is subjected to the largest stress in a use situation, is formed from parallel frame plates.

In an advantageous embodiment of the method according to the invention the frame plates are formed from ultra-strength steel. The frame plates are advantageously formed by machining a steel plate of ultra-strength steel only with machining methods, which do not substantially heat up the material being machined. Such machining methods, which are suited for use in the method and which do not heat up the substance, are for example chipping machining methods, such as milling and drilling, and water cutting and water moulding. Using ultra-strength steel can decrease the amount of steel needed in manufacturing the frame and the use of machining methods which do not heat up the substance ensures that the strength of the ultra-strength steel does not decrease in connection with forming the frame plates.

In a second advantageous embodiment of the method according to the invention end surfaces are formed in the lower branches and upper branches, which end surfaces are transverse in relation to the longitudinal direction of the branches. The lower branches are advantageously attached by their end surface to the lower end plate and the upper branches are attached by their end surface to the upper end plate with mechanical attaching means, such as bolts or rivets, or by gluing. Thus no thermal stresses are generated even in the assembly stage of the frame of the C-clamp, which thermal stresses could decrease the strength of the ultra-strength steel. The lower and upper branches can be attached by their end surfaces to the end plates also by welding. Because the attaching point of the end plates is situated as far away as possible from the most stressed point of the frame plates, it is believed that a localized decrease in strength in the ultra-strength steel possibly caused by the welding does not affect the total strength of the frame in a decreasing way.

The method according to the invention can be used to form differently sized frames of C-clamps for differently sized C-clamps. The strength of the frame can easily be increased by increasing the number of frame plates. Thus three, four, five, six, seven or eight frame plates can be formed for manufacturing the frame, the lower branches of which frame plates are attached to the lower end plate and the upper branches to the upper end plate.

The frame of the C-clamp according to the invention has a lower jaw, an upper jaw and a mouth between the lower jaw and the upper jaw. Said frame comprises at least two parallel frame plates at a distance e from each other, which frame plates have a lower branch and an upper branch and a gap between them. The frame further comprises a lower end plate connecting the lower branches and an upper end plate connecting the upper branches. The frame is thus built completely from plate-like parts connected together. The number of frame plates can be selected according to the strength requirements of the frame. There can thus be for example three, four, five, six, seven or eight frame plates. When using a C-clamp a large bending moment is generated in the curved juncture between the upper jaw and the lower jaw of the frame. In the frame of the C-clamp according to the invention this bending moment is received precisely with the aid of the frame plates. The frame plates are dimensioned to withstand the stresses generated in the frame of the C-clamp.

In an advantageous embodiment of the frame of the C-clamp according to the invention the material of said frame plates is ultra-strength steel. Said frame plates are advantageously formed by machining a steel plate of ultra-strength steel substantially only with machining methods which do not heat up the material being machined, such as with chipping machining methods or water cutting.

In a second advantageous embodiment of the frame of the C-clamp according to the invention there are end surfaces in the lower branches and upper branches, which end surfaces are transverse in relation to the longitudinal direction of the branches. The lower branches are attached by their end surface to the lower end plate and the upper branches are attached by their end surface to the upper end plate advantageously with mechanic attaching means, such as bolts or rivets, or glue.

It is an advantage of the invention that significantly less steel is needed for manufacturing the C-clamp than in prior art methods. Thus significant savings are obtained in the manufacturing costs of the clamp. A decreased material use further results in a significant lightening and decrease in the physical dimensions of the C-clamp, which makes handling the clamp easier.

It is further an advantage of the method according to the invention that it can easily be applied to manufacturing C-clamps of different sizes and different types, without significant investments in the manufacturing apparatus.

In the following, the invention will be described in detail. In the description, reference is made to the appended drawings, in which

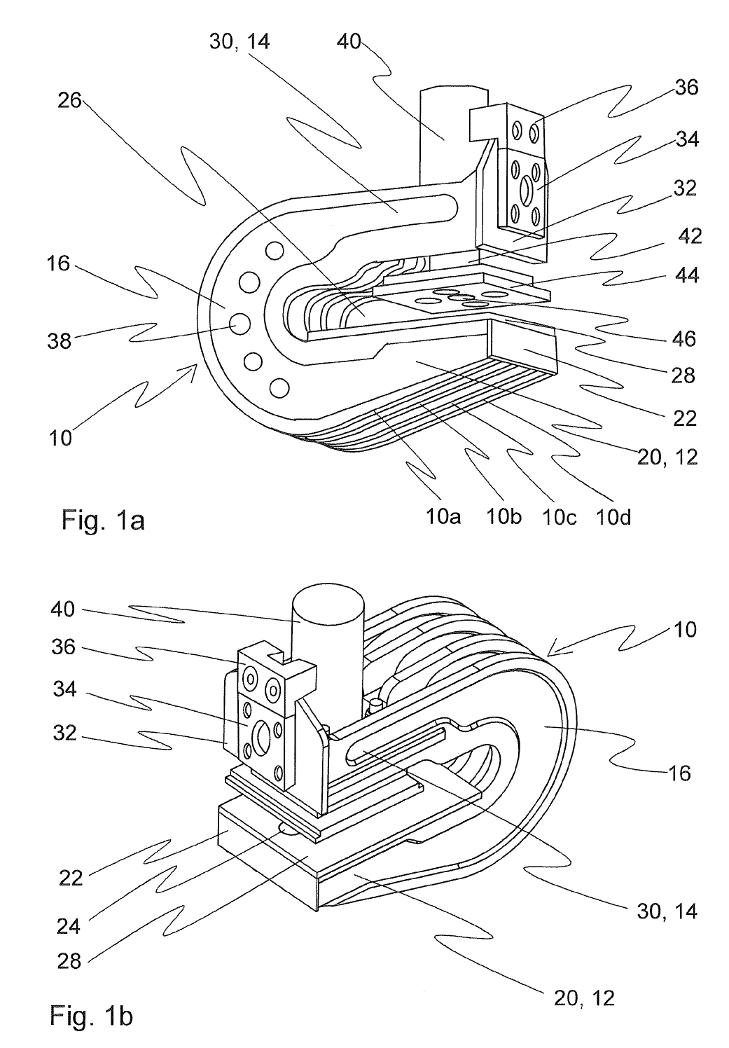

FIG. 1a shows as an example a C-clamp according to the invention seen diagonally from below,

FIG. 1b shows as an example the C-clamp of FIG. 1a seen diagonally from above,

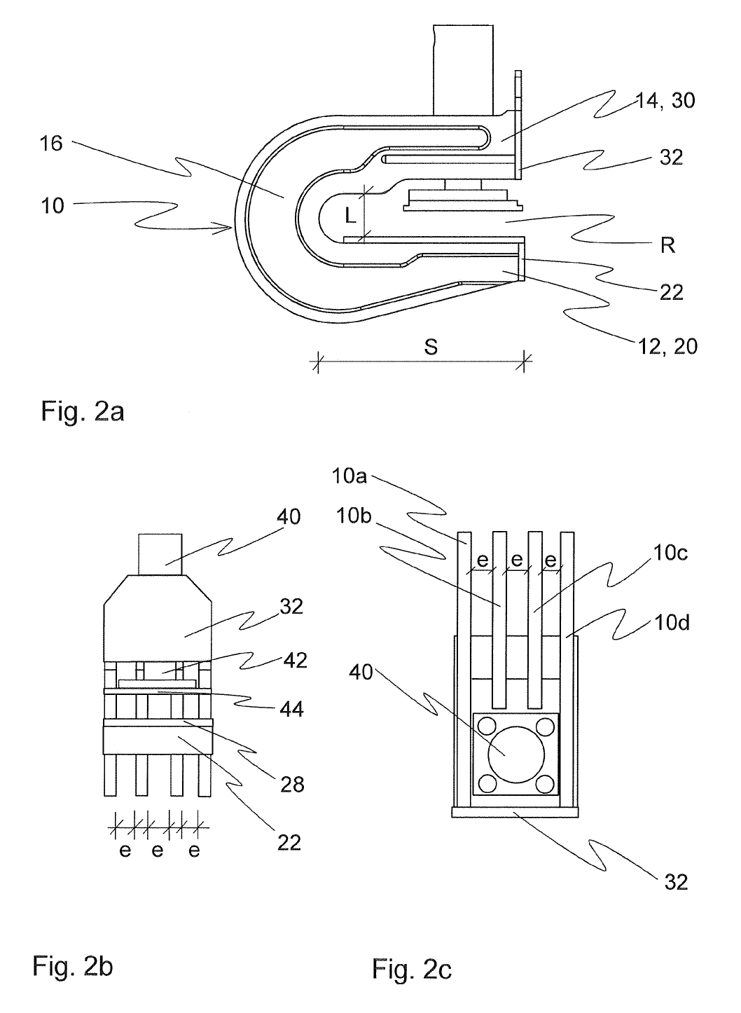

FIG. 2a shows as an example a C-clamp according to the invention seen from the side,

FIG. 2b shows as an example the clamp of FIG. 2a seen from the front and

FIG. 2c shows as an example the clamp of FIG. 2a seen from above.

FIGS. 1a and 1b show as an example a C-clamp according to the invention seen from two different directions. The C-clamp has a frame 10 which in accordance to its name is reminiscent of a letter C, or rather a letter U on its side, which has a solid lower jaw 20 and a solid upper jaw 30, between which a free mouth 26 remains. A hydraulic cylinder 40 is attached to the upper jaw in a position transverse to the longitudinal axis of the upper jaw, so that the free end of the protruding piston 42 of the hydraulic cylinder is situated in the mouth between the upper jaw and lower jaw. In the free end of the piston there is a clamp plate 44, where a permanent magnet 46 is situated. In the surface of the lower jaw, which is toward the upper jaw, there is a counter plate 28, where an electric magnet 24 is placed (FIG. 1b). The clamp plate and the counter plate are situated against each other in the jaws of the C-clamp, so that the clamp plate can by moving the piston of the hydraulic cylinder be moved toward the counter plate or away from it.

The frame 10 of the C-clamp shown in FIGS. 1a and 1b is built from four parallel frame plates 10a, 10b, 10c, 10d. The frame plates are substantially identically shaped parts reminiscent of a letter C or U, which have a lower branch 12 and an upper branch 14, which are connected together in the curved base part 16 of the frame plate. The frame plates may have holes 38 or cavities in order to decrease the weight of the frame 10. A lower end plate 22 is attached to the end surfaces of the lower branches and an upper end plate 32 to the end surfaces of the upper branches, which end plates attach the frame plates at a standard distance from each other. In the upper end plate there is an attaching socket 34, by means of which the C-clamp can be attached to a work machine, such as to the articulated arm of an assembly robot. (The assembly robot is not shown in the figures.) In the upper end plate there is further a hydraulics bayonet catch 36, which is connected with hydraulic pipes to the hydraulic cylinder 40 (the hydraulic pipes are not shown in the figures). By means of the bayonet catch the hydraulic cylinder of the C-clamp can be connected to an external hydraulic system.

In the method according to the invention the frame of the C-clamp is manufactured from several separate frame plates 10a, 10b, 10c, 10d, the lower branches 12 of which are attached by their end surfaces to the lower end plate 22 and the upper branches 14 of which are connected by their end surfaces to the upper end plate 32. In the method the individual frame plates are manufactured from ultra-strength steel. Ultra-strength steels generally mean structural steels, the yield strength of which is higher than 560 N/mm². In the method the frame plates are manufactured from an ultra-strength structural steel, the yield strength of which is 690-700 N/mm². One such ultra-strength type of steel suitable for manufacturing the frame plates is Optim 700 MC structural steel manufactured by Rautaruukki. The high strength of ultra-strength steels is based on their manufacturing technique, where thermo-mechanical rolling and quick cooling down is used. Thus the breakdown of austenite into fine-grained martensite is achieved. A problem with ultra-strength steels is that their crystal structure changes already at a low thermal treatment, which leads to a decrease in the strength of the steel. Already the flame cutting of steel plates into a desired shape or the welding of the plates often produces so much heat that it leads to a decrease in the strength of ultra-strength steels. The decrease in strength is typically localized, i.e. it occurs only in the vicinity of the point where the steel was thermally treated, i.e. the welding or flame cutting point.

In chipping machining methods, such as drilling or milling, or in water cutting, a significant amount of heat is however not generated. In chipping machining methods the generated heat can also efficiently be removed by means of liquid cooling. Machining ultra-strength steels with machining methods, which do not heat up the substance, such as chipping machining methods or water cutting, does thus not lead to a significant decrease in their strength.

In the manufacturing method of C-clamps according to the invention the above-mentioned information is utilised for example so that the individual frame plates 10a, 10b, 10c, 10d are manufactured from a steel plate of ultra-strength steel with chipping machining methods, such as drilling and milling. Heat is thus not generated in the forming of an individual frame plate to such an amount that it would lead to a decrease in the strength of the frame plate at the manufacturing stage of the frame plate. The lower branches 12 of the individual frame plates are attached by their end surfaces by welding to the lower end plate 22 and the upper branches are attached by their end surfaces by welding to the upper end plate 32. The frame plates and end plates, which are welded to each other, together form the frame of the C-clamp. The most stressed part of the frame plates is naturally in the curved base part 16 of the frame plates, where the frame plate is divided into the upper branch and the lower branch. A large bending moment is directed to this point of the frame when using the clamp, which bending moment causes tensile stresses in the base part. The base part is however so far away from the welding point, i.e. the end surfaces of the branches 12, 14, that the heat generated in the welding does not cause changes in the crystal structure of the steel. Thus the strength of the most stressed part of the frame plates, i.e. the base part, is also not decreased in the assembly stage of the frame. The heat generated in the welding decreases the strength of the branches 12, 14 in the vicinity of the upper and lower end plates. In this part the stress directed at the branches is however significantly smaller that in the base part, so the locally decreased strength of the steel is still sufficient. In C-clamps manufactured with the method according to the invention the strength of ultra-strength steels can thus be fully utilized.

After the frame 10 has been manufactured, a counter plate 28 is attached to the lower jaw 20 and a hydraulic cylinder 40 is attached to the upper jaw. The hydraulic cylinder is attached to the upper jaw with a bolt attachment and the counter plate is attached to the edge of the lower jaw, which is toward the mouth 26, with a welding attachment. The welding attachment is done only on the area of the counter plate, which is toward the lower end plate, i.e. the welding is not extended close to the base part of the frame plates. A hydraulics bayonet catch 36, hydraulic tubes belonging to the hydraulics and an attaching socket 34 are additionally attached to the upper end plate with a bolt connection. Thereafter the C-clamp is completed.

FIGS. 2a, 2b and 2c show the C-clamp according to the invention shown in FIGS. 1a and 1b seen from different directions. FIG. 2a shows the clamp seen from the side, FIG. 2b seen from the front and FIG. 2c seen from above. The figures do not show the attaching socket or the hydraulics bayonet catch. Between the upper branch and the lower branch of the frame plates there is a gap R, which is open at its one end, the width L of which defines the height of the mouth of the clamp frame and the depth S of which defines the depth of the mouth of the clamp (FIG. 2a). From the figures can be seen that the parallel frame plates 10a, 10b, 10c, 10d are at a distance e from each other (FIG. 2b, 2c). The distances between the frame plates can be selected to be suitable in the manufacturing stage of the frame of the C-clamp. Thus the distance may be for example 0.5, 1.0, 1.5, 2.0, 2.5 or 3 times as wide as the thickness of the frame plate. All the mutual distances between the frame plates do not need to be of the same size, i.e. the free space between adjacent frame plates in the same frame of a C-clamp may vary. In the figures there are four frame plates. It is clear to every skilled person that the number and the thickness of the frame plates is determined according to the stresses directed to the frame. There can thus be a different number of frame plates depending on the use purpose and dimensions of the C-clamp, for example 2, 3, 4, 5, 6, 7, 8 or over 8 frame plates.

Some advantageous embodiments of the method and frame of the C-clamp according to the invention have been described above. The invention is not limited to the solutions described above, but the inventive idea can be applied in numerous ways within the scope of the claims.

1. A method for manufacturing a frame of a C-clamp, which frame has a lower jaw, an upper jaw and a mouth between the lower jaw and the upper jaw, the method comprising:
forming at least two frame plates, which have a lower branch and an upper branch and a gap remaining between them,
forming a lower end plate and an upper end plate,
attaching the lower branches of said frame plates to the lower end plate and the upper branches to the upper end plate, so that the frame plates settle in a parallel manner at a distance from each other.

2. The method according to claim 1, wherein the frame plates are formed from ultra-strength steel.

3. The method according to claim 2, wherein the frame plates are formed by machining a steel plate of ultra-strength steel only with machining methods, which substantially do not heat up the material being machined.

4. The method according to claim 3, wherein the frame plates are formed by machining a steel plate of ultra-strength steel with chipping machining methods, such as by milling or drilling.

5. The method according to claim 3, wherein the frame plates are formed by machining a steel plate of ultra-strength steel with water cutting or water moulding method.

6. The method according to claim 1, wherein end surfaces, which are transverse in relation to the longitudinal direction of the branches, are formed in the lower branches and upper branches, and the lower branches are attached by their end surface to the lower end plate and the upper branches are attached by their end surface to the upper end plate.

7. The method according to claim 1, wherein the lower branches are attached to the lower end plate and the upper branches are attached to the upper end plate with mechanical attaching means.

8. The method according to 1, wherein the lower branches are attached to the lower end plate and the upper branches are attached to the upper end plate by gluing.

9. The method according to claim 1, wherein the method comprises forming three, four, five, six, seven or eight said frame plates, the lower branches of which frame plates are attached to the lower end plate and the upper branches of which are attached to the upper end plate.

10. A frame of a C-clamp, which has a lower jaw, an upper jaw and a mouth between the lower jaw and the upper jaw, wherein said frame comprises at least two parallel frame plates at a distance from each other, which frame plates have a lower branch and an upper branch and a gap between them and a lower end plate connecting the lower branches and an upper end plate connecting the upper branches.

11. The frame of a C-clamp according to claim 10, wherein said frame plates are made of ultra-strength steel.

12. The frame of a C-clamp according to claim 10, wherein said frame plates are formed by machining a steel plate of ultra-strength steel only with machining methods, which substantially do not heat up the material being machined.

13. The frame of a C-clamp according to claim 10, comprising end surfaces, which are transverse in relation to the longitudinal direction of the branches, in the lower branches and upper branches, and the lower branches are attached by their end surface to the lower end plate and the upper branches are attached by their end surface to the upper end plate.

14. The frame of a C-clamp according to claim 10, wherein the lower branches are attached to the lower end plate and the upper branches are attached to the upper end plate with mechanical attaching means, such as bolts or rivets.

15. The frame of a C-clamp according to claim 10, wherein the lower branches are attached to the lower end plate and the upper branches are attached to the upper end plate by gluing.

16. The frame of a C-clamp according to claim 10, it comprising three, four, five, six, seven or eight said frame plates.

17. A C-clamp, which clamp has a frame, which has a lower jaw, an upper jaw and a mouth between the lower jaw and the upper jaw, wherein said frame comprises at least two parallel frame plates at a distance from each other, which frame plates have a lower branch and an upper branch and a gap between them and a lower end plate connecting the lower branches and an upper end plate connecting the upper branches.
